(19) United States
(12) Patent Application Publication
(10) Pub. No.: US 2024/0388462 A1
(43) Pub. Date: Nov. 21, 2024

(54) MEETING ASSISTANCE SYSTEM, MEETING ASSISTANCE METHOD, AND MEETING ASSISTANCE PROGRAM

(71) Applicant: DWANGO Co., Ltd., Tokyo (JP)

(72) Inventor: Akihiko KOIZUKA, Tokyo (JP)

(73) Assignee: DWANGO Co., Ltd., Tokyo (JP)

(21) Appl. No.: 18/292,257

(22) PCT Filed: Jul. 4, 2022
(86) PCT No.: PCT/JP2022/026624

§ 371 Date: Jan. 25, 2024

(30) Foreign Application Priority Data
Aug. 31, 2021 (JP) 2021-140963

(51) Int. Cl. H04L 12/18; G10L 17/00

(52) U.S. Cl. CPC H04L 12/1831; G10L 17/00

(57) ABSTRACT

A meeting assistance system according to an aspect of the present disclosure includes at least one processor. The at least one processor is configured to: record meeting data including audio of an online meeting; obtain a time point the online meeting is to be traced back from a terminal of one user; generate content corresponding to the meeting data for a time range from the time point and thereafter, and cause the terminal of the user to reproduce the content at a reproduction speed faster than an original reproduction speed of the meeting data while the online meeting is in progress.

### CROSS REFERENCE TO RELATED APPLICATION(S)

This application is a U.S. National Stage filing under 35 U.S.C. § 371 of PCT Application No. PCT/JP2022/026624, filed Jul. 4, 2022, which claims priority to Japanese Application No. 2021-140963, filed Aug. 31, 2021, which are incorporated herein by reference, in their entirety, for any purpose.

### TECHNICAL FIELD

An aspect of the present disclosure relates to a meeting assistance system, a meeting assistance method, and a meeting assistance program.

### BACKGROUND ART

A mechanism to assist grasping of meeting content at an online meeting via a network is known. For example, Patent Document 1 describes a network meeting system that records meeting information while the meeting is in progress, and when an attendee who has joined the meeting in the middle thereof is detected, creates a summary of the meeting information up to that point and separately provides the created summary to the half-way attendee. Patent Document 2 describes a video conference system that rewinds and reproduces a video image or an audio of speech if an electronic conference participant misses that speech.

### CITATION LIST

### Patent Documents

Patent Document 1: Japanese Unexamined Patent Publication No. 2003-339033
Patent Document 2: Japanese Unexamined Patent Publication No. 2008-236553

### SUMMARY OF THE INVENTION

### Technical Problems

There is a demand for a system that allows an attendee of an online meeting to grasp the content of the meeting before the current point in time.

### Solution to the Problems

A meeting assistance system according to an aspect of the present disclosure includes at least one processor. The at least one processor may: record meeting data including audio of an online meeting; obtain a time point the online meeting is to be traced back from a terminal of a user; generate a content corresponding to the meeting data for a time range from the time point and thereafter; and cause the terminal of the user to reproduce the content at a reproduction speed faster than an original reproduction speed of the meeting data while the online meeting is in progress.

In the above-described aspect, the content corresponding to the meeting data at or later than a time point to which the online meeting is traced back is generated. Then, the content is reproduced at high speed on the terminal of the user so as to let the user catch up with the online meeting in progress. This provides an environment that allows grasping of the content of the meeting before the current time point.

### Advantages of the Invention

An aspect of the present disclosure provides an environment that allows grasping of the content of the meeting before the current time point.

### BRIEF DESCRIPTION OF THE DRAWINGS

FIG. 1 is a diagram showing an exemplary application of a meeting assistance system according to an embodiment.

FIG. 2 is a diagram showing an exemplary hardware configuration related to the meeting assistance system according to the embodiment.

FIG. 3 is a diagram showing an exemplary functional configuration related to the meeting assistance system according to the embodiment.

FIG. 4 is a diagram showing an exemplary meeting screen.

FIGS. 5A and 5B are diagrams showing an exemplary reproduction screen. The example of FIG. 5A is an exemplary reproduction screen that is one frame constituting the first half of content. The example of FIG. 5B is an exemplary reproduction screen that is one frame constituting the latter half of content.

FIG. 6 is a sequence diagram showing an exemplary operation of a meeting assistance system according to the embodiment.

FIG. 7 is a diagram showing an exemplary functional configuration related to the meeting assistance system according to another embodiment.

FIGS. 8A and 8B are diagrams showing another exemplary meeting screen. The example of FIG. 8A is an exemplary meeting screen displaying a status and a progress state. The example of FIG. 8B is another exemplary meeting screen displaying a status and a progress state.

FIG. 9 is a sequence diagram showing an exemplary operation of a meeting assistance system according to another embodiment.

### DESCRIPTION OF EMBODIMENTS

Embodiments of the present disclosure will be described in detail below with reference to the attached drawings. In the description of the drawings, the same or equivalent elements are denoted by the same reference numbers and characters, and their descriptions are not repeated.

### Overview of System

A meeting assistance system according to an embodiment is a computer system that assists users of an online meeting. The online meeting refers to a meeting via a plurality of user terminals connected to a network, and is also referred to as a web meeting or a network meeting. The users are people who use the meeting assistance system. The user terminals are each a computer used by one or more users. The “assist users” is done by providing the users with progress of the online meeting before the current time point, in the form of content. The content is data that a human is able to recognize some information, at least through hearing. The content may be a moving image (video) including audio or may only be audio. The providing means a process of transmitting information to the user terminal via the network.

The meeting assistance system obtains, from a user terminal, a request which designates a time point the online meeting is to be traced back. The time point the online meeting is to be traced back is a point in time at which the reproduction of the content is to be started (hereinafter, referred to as a “content start time point”). The meeting assistance system generates content data that is electronic data indicative of content, based on the content start time point and electronic data recorded in the online meeting, and transmits the content data to the user terminal. The user terminal receives and processes the content data, and executes chasing playback of the content at high speed. The chasing playback is a function of reproducing, with a delay, the audio being recorded or the video image being recorded.

The “content (progress) of the meeting (online meeting) before the current time point” includes progress of the meeting within a first range from the content start time point to a time point the content start time point is designated (in other words, the time point the chasing playback is instructed). The real-time meeting continues while the chasing playback of the content corresponding to the first range is executed. The “content (progress) of the meeting (online meeting) before the current time point” may further include progress of the meeting within a second range from the time point the content start time point is designated (the time point the chasing play back is instructed) to the current time point. The progress of the meeting in the second range is the content of the meeting that continues to progress during the chasing play back.

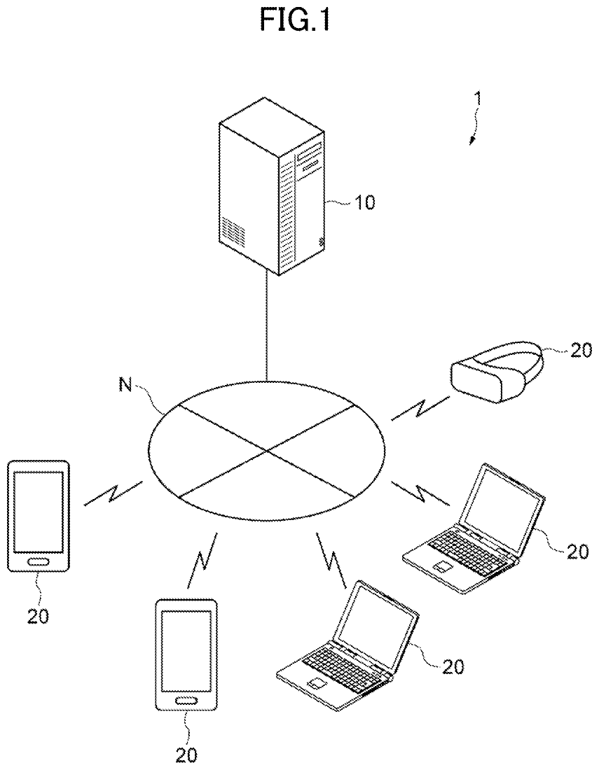

FIG. 1 is a diagram showing an exemplary application of a meeting assistance system 1. In the present embodiment, the meeting assistance system 1 includes a server 10. The server 10 is a computer (meeting assistance server) that transmits content to at least one user terminal 20. The server 10 is connected to a plurality of user terminals 20 via a communication network N. Although five user terminals 20 are shown in FIG. 1, the number of user terminals 20 is not limited. The configuration of the communication network N is not limited. For example, the communication network N may include the internet or an intranet. As illustrated in FIG. 1, the type of the user terminal 20 is not limited. For example, the user terminal 20 may be a mobile terminal such as a high-function mobile phone (smartphone), a tablet terminal, a wearable terminal (for example, a head-mounted display (HMD), smart glasses, or the like), a laptop personal computer, or a mobile phone. Alternatively, the user terminal 20 may be a stationary terminal such as a desktop personal computer.

The content in the present disclosure is a moving image which is a combination of a photographed image and audio. The photographed image refers to an image obtained by capturing a real world, and is obtained by an imaging apparatus such as a camera. The meeting assistance system 1 may be used for various purposes. For example, the meeting assistance system 1 may be used for a video conference (a video meeting), an online seminar, or the like. That is, the meeting assistance system 1 may be used in communication sharing a moving image among a plurality of users. Alternatively, the meeting assistance system 1 may be used for a telephone meeting or the like sharing only audio.

### System Configuration

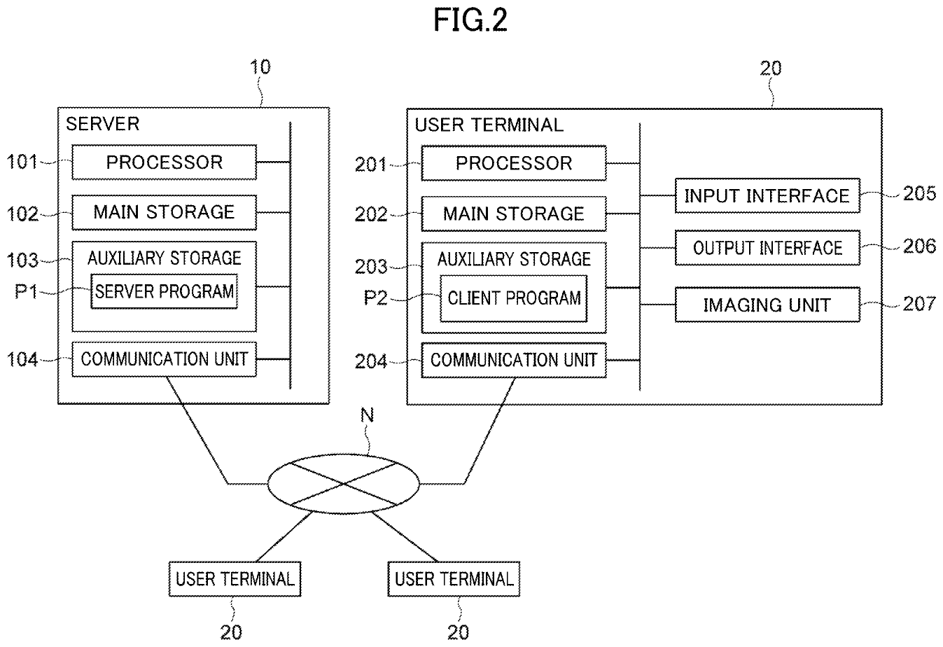

FIG. 2 is a diagram illustrating an exemplary hardware configuration related to the meeting assistance system 1. For example, the server 10 includes a processor 101, a main storage 102, an auxiliary storage 103, and a communication unit 104 as hardware components. The processor 101 is a computing device that executes an operating system and application programs. Examples of the processor include a central processing unit (CPU) and a graphics processing unit (GPU). However, the type of the processor 101 is not limited to these.

The main storage 102 is a device that stores a program causing the server 10 to function, computation results output from the processor 101, and the like. The main storage 102 is constituted by, for example, at least one of a read-only memory (ROM) or random access memory (RAM).

The auxiliary storage 103 is generally a device capable of storing a larger amount of data than the main storage 102. The auxiliary storage 103 is constituted by a non-volatile storage medium such as a hard disk or a flash memory. The auxiliary storage 103 stores a server program Pl that causes at least one computer to function as the server 10 and stores various types of data. In the present embodiment, a meeting assistance program is implemented as a server program P1.

The communication unit 104 is a device that executes data communication with another computer via the communication network N. The communication unit 104 is constituted by, for example, a network card or a wireless communication module.

Each functional element of the server 10 is achieved by causing the processor 101 or the main storage 102 to read the server program PI and executing the program. The server program Pl includes codes that achieve the functional elements of the server 10. The processor 101 operates the communication unit 104 according to the server program PI, and executes reading and writing of data from and to the main storage 102 or the auxiliary storage 103. Through such processing, each functional element of the server 10 is achieved.

The server 10 may be constituted by one or more computers. In a case of using a plurality of computers, the computers are connected to each other via the communication network N, thereby logically configuring single server 10.

In one example, the user terminal 20 includes, as hardware components, a processor 201, a main storage 202, an auxiliary storage 203, a communication unit 204, an input interface 205, an output interface 206, and an imaging unit 207.

The processor 201 is a computing device that executes an operating system and application programs. The processor 201 may be, for example, a CPU or a GPU, but the type of the processor 201 is not limited to these.

The main storage 202 is a device that stores a program causing the user terminal 20 to function, computation results output from the processor 201, and the like. The main storage 202 is constituted by, for example, at least one of ROM or RAM.

The auxiliary storage 203 is generally a device capable of storing a larger amount of data than the main storage 202. The auxiliary storage 203 is constituted by a non-volatile storage medium such as a hard disk or a flash memory. The auxiliary storage 203 stores a client program P2 for causing a computer to function as the user terminal 20, and various data.

The communication unit 204 is a device that executes data communication with another computer via the communication network N. The communication unit 204 is constituted by, for example, a network card or a wireless communication module.

The input interface 205 is a device that receives data based on a user's operation or action. For example, the input interface 205 includes at least one of a keyboard, an operation button, a pointing device, a microphone, a sensor, or a camera. The keyboard and the operation button may be displayed on the touch panel. The type of the input interface 205 is not limited, and neither is data input thereto. For example, the input interface 205 may receive data input or selected by a keyboard, an operation button, or a pointing device. Alternatively, the input interface 205 may receive audio data input through a microphone. Alternatively, the input interface 205 may receive, as motion data, data representing a user's non-verbal activity (e.g., line of sight, gesture, facial expression, or the like) detected by a motion capture function using a sensor or a camera.

The output interface 206 is a device that outputs data processed by the user terminal 20. For example, the output interface 206 is constituted by at least one of a monitor, a touch panel, an HMD, or an audio speaker. A display device such as a monitor, a touch panel, or an HMD displays processed data on a screen. The audio speaker outputs audio represented by the processed audio data.

The imaging unit 207 is a device that captures an image of the real world, and is a camera, specifically. The imaging unit 207 may capture a moving image (video) or a still image (photograph). In a case of capturing a moving image, the imaging unit 207 processes video signals based on a given frame rate so as to yield a time-sequential series of frame images as a moving image. The imaging unit 207 can also function as the input interface 205.

Each functional element of the user terminals 20 is achieved by causing the processor 201 or the main storage 202 to read the client program P2 and executing the program. The client program P2 includes code for achieving each functional element of the user terminal 20. The processor 201 operates the communication unit 204, the input interface 205, the output interface 206, or the imaging unit 207 in accordance with the client program P2 to read and write data from and to the main storage 202 or the auxiliary storage 203. Through this processing, each functional element of the user terminal 20 is achieved.

At least one of the server program PI or the client program P2 may be provided after being permanently recorded on a tangible recording medium such as a CD-ROM, a DVD-ROM, or a semiconductor memory. Alternatively, at least one of these programs may be provided via a communication network N as a data signal superimposed on a carrier wave. These programs may be separately provided or may be provided together.

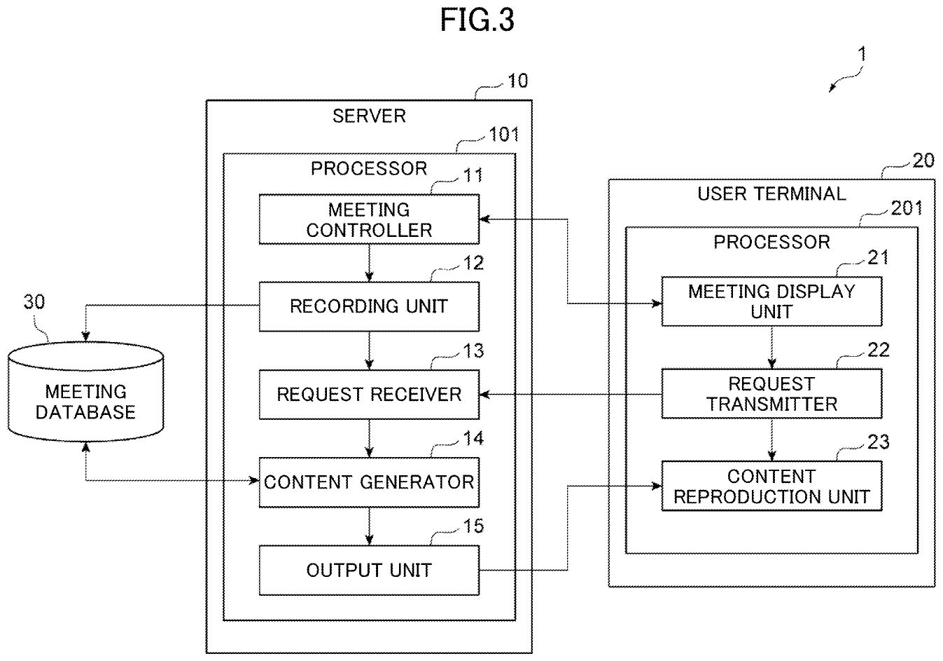

FIG. 3 is a diagram illustrating an exemplary functional configuration related to the meeting assistance system 1. The server 10 includes, as its functional elements, a meeting controller 11, a recording unit 12, a request receiver 13, a content generator 14, and an output unit 15. The meeting controller 11 is a functional element that controls display of an online meeting on the user terminal 20. The recording unit 12 is a functional element that records meeting data containing the audio of the online meeting. The request receiver 13 is a functional element that receives from the user terminal 20 a content generation request containing the content start time point. The content generator 14 is a functional element that generates content data based on the content start time point and the meeting data. The content data has a time range from the content start time point until catching up with the real-time meeting. The content data is, for example, one or more sets of data in a form of streaming. The output unit 15 is a functional element that transmits the content data to the user terminal 20.

The user terminal 20 includes, as its functional elements, a meeting display unit 21, a request transmitter 22, and a content reproduction unit 23. The meeting display unit 21 is a functional element that displays an online meeting in cooperation with the meeting controller 11 of the server 10. The request transmitter 22 is a functional element that transmits a content generation request to the server 10. The content reproduction unit 23 is a functional element that reproduces content data received from the server 10.

A meeting database 30 is a non-transitory storage medium or a storage device which stores meeting data that is electronic data of the online meeting. The meeting data in the present disclosure is a moving image containing audio of the online meeting. The meeting data may contain user identification information that specifies a user who is a speaker of the audio.

### Operation of System

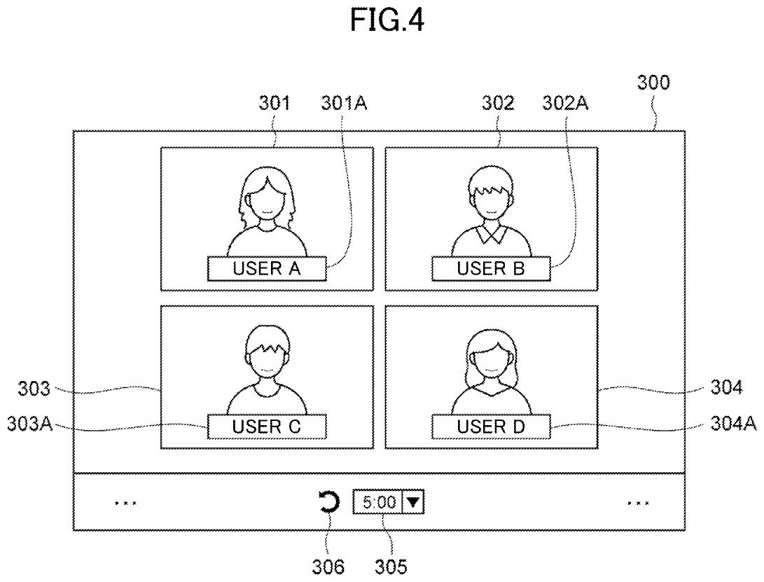

FIG. 4 is a diagram showing an exemplary meeting screen 300. The meeting screen 300 is a screen that displays in real time an online meeting in progress. The meeting screen 300 is displayed on the user terminals 20 of users attending the online meeting. For example, the meeting screen 300 is displayed on the user terminal 20 of each of four users (user A, user B, user C, and user D). The meeting screen 300 includes, for example, display areas 301 to 304, name indication labels 301A to 304A, a time point input field 305, and a chasing playback button 306.

The display areas 301 to 304 are screen areas for displaying a moving image of each user. The moving image of each user is a moving image of the user captured by the user terminal 20. The number of display areas 301 to 304 corresponds to the number of users. For example, the four display areas 301 to 304 display the moving images of the four users, respectively. When the number of users increases or decreases, the number of display areas also increases or decreases. The display areas 301 to 304 may each display one frame image constituting the moving image or may display one still image. The display areas 301 to 304 may be highlighted while the displayed user is speaking.

The name indication labels 301A to 304A are each a screen area for displaying the name of the user attending the online meeting. The name of the user may be set by receiving an input by the user when the user attends the online meeting. Further, the name of the user may be recorded in the meeting database 30 as the user identification information. The name indication labels 301A to 304A correspond to the display areas 301 to 304, respectively, in a one-to-one manner. For example, the display area 301 displays the moving image of the user A and the name of the user A in the name indication label 301A.

The time point input field 305 is a screen element that receives a user input related to the content start time point. The time point input field 305 receives an input operation or a selection operation of the content start time point such as a time point of 5 minutes before. The chasing playback button 306 is a screen element used when performing the chasing playback from the content start time point input in the time point input field 305. The form of the time point input field 305 and the chasing play back button 306 is not limited to this, and for example, it is possible to display only the chasing playback button 306 whereas the content start time point is made a fixed value.

The display of the meeting screen 300 is controlled by the meeting controller 11 of the server 10 and the meeting display unit 21 of the user terminal 20 cooperating with each other. For example, the meeting display unit 21 captures a moving image of the user and transmits the moving image and the user identification information to the server 10. The meeting controller 11 generates the meeting screen 300 based on the moving images and the user identification information received from the plurality of user terminals 20, and transmits the meeting screen 300 to the user terminal 20 of each user. The meeting display unit 21 processes the meeting screen 300 and displays the meeting screen 300 on the display device.

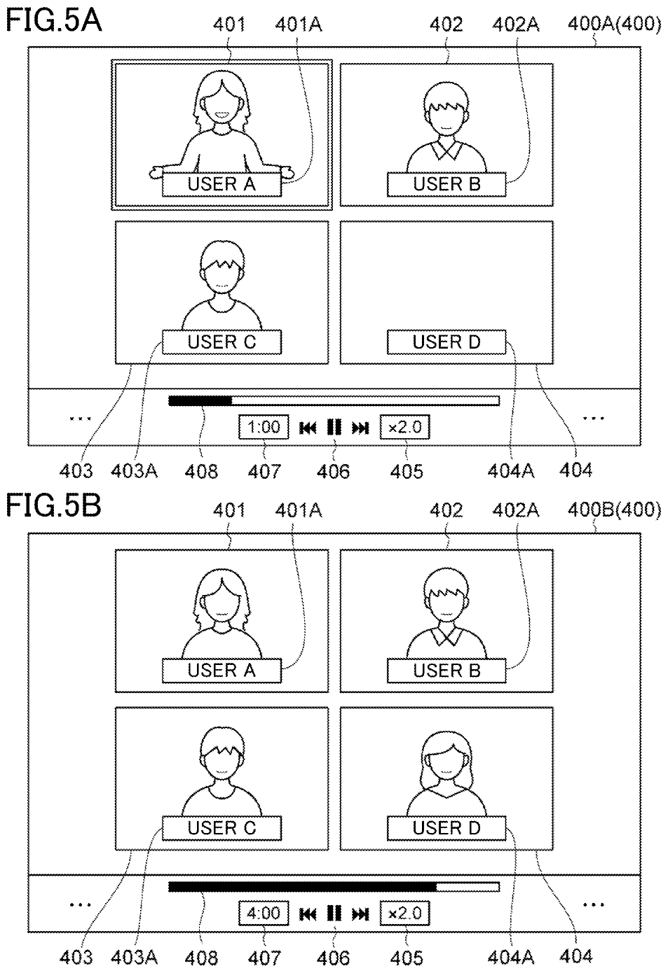

FIGS. 5A and 5B are diagrams showing an exemplary reproduction screen 400. The reproduction screen 400 is a screen for displaying the progress of the online meeting in the past. More specifically, the reproduction screen 400 is a screen that displays the progress of the online meeting of the past, which was recorded from the content start time point to a time point that catches up with the real-time progress. For example, the reproduction screen 400 is displayed on the user terminal 20, triggered by pressing of the chasing play back button 306 on the meeting screen 300. The user may miss the meeting content or simply wish to listen to the meeting content again for various reasons, such as the user being away from the meeting, or communication through the communication network N being poor, and the like. In such cases, the user confirms the meeting content by the content chasing playback. For example, after the user D, who was temporarily away from the meeting, returns, the user D plays the chasing play back from the time point the user D went away from the meeting. In this case, the first half of the content shows a scene where the user D is absent, and the second half of the content shows a scene where the user D who has returned to his or her seat is playing the chasing playback of the content. The following assumes that the reproduction screen 400 is displayed on the user terminal 20 of the user D who was temporarily away from the meeting.

The example of FIG. 5A shows, as the exemplary reproduction screen 400, a reproduction screen 400A that is one frame constituting the first half of the content. The reproduction screen 400A is a screen for grasping the content of the meeting in the past time. The reproduction screen 400A includes display areas 401 to 404, name indication labels 401A to 404A, reproduction speed field 405, an operation interface 406, a reproduced time field 407, and a progress bar 408.

The display areas 401 to 404 and the name indication labels 401A to 404A correspond to the display areas 301 to 304 and the name indication labels 301A to 304A of the meeting screen 300, respectively. The display area 401 is emphasized by a double frame, and the user D is not displayed in the display area 404. That is, the reproduction screen 400A indicates that the user A is speaking and that the user D is away from the meeting.

The reproduction speed field 405 is a screen element that indicates a reproduction speed of the content. The reproduction speed of the content is a reproduction speed higher than the original reproduction speed of the meeting data. By the original reproduction speed, it means the reproduction speed of the meeting data without a change. The reproduction speed of the content is, for example, n times (n>1.0) the original reproduction speed. In one example, the reproduction speed of the content is 2.0 times. The reproduction speed field 405 may receive a user input related to a change in the reproduction speed of the content.

The operation interface 406 is a user interface for performing various operations related to the reproduction of content. The operation interface 406 receives an operation from the user in relation to, for example, switching between reproduction and pause, cueing, and the like.

The reproduced time field 407 is a screen element that indicates the time elapsed from the start of the reproduction of the content. The progress bar 408 is a screen element that indicates the progress rate of the content in the time range. That is, the reproduced time field 407 and the progress bar 408 indicate a reproduction position of the content.

The example of FIG. 5B shows, as an exemplary reproduction screen 400, a reproduction screen 400B that is one frame constituting the second half of the content. The reproduction screen 400B is a screen for grasping the content of the meeting in progress during the chasing play back. For the reproduction screen 400B, the reproduction position indicated by the reproduced time field 407 and the progress bar 408 is later than that of the reproduction screen 400A. That is, the reproduction screen 400B indicates that more time has elapsed from the reproduction screen 400A. The display area 404 displays the moving image of the user D. This indicates that the user D has returned to the meeting. The reproduction screen 400B shows a state of the online meeting where the user D is reproducing the content. That is, the reproduction screen 400B shows a state where the user A, the user B, and the user C are carrying on the online meeting, while the user D in the middle of reproducing the content is not participating in the meeting.

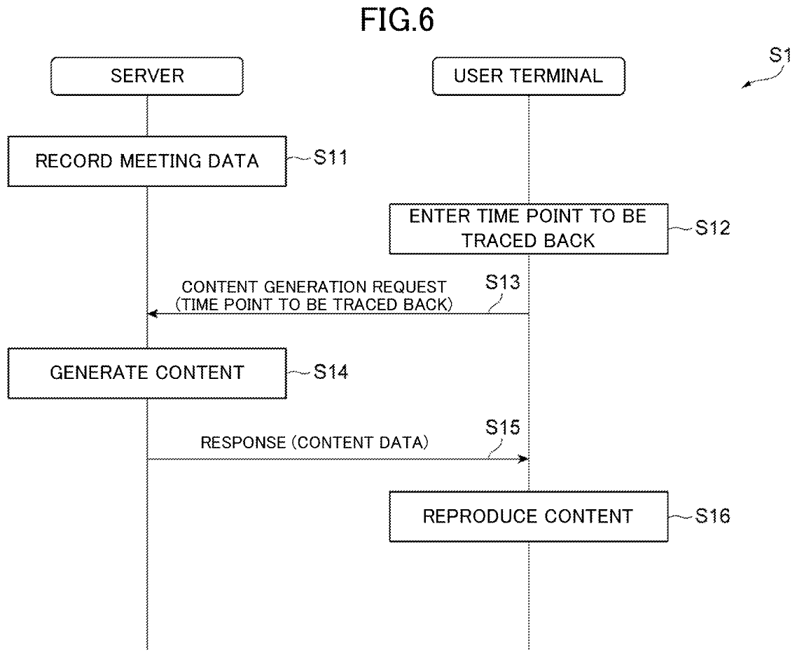

The following describes an operation of the meeting assistance system 1 and a meeting assistance method of the present embodiment with reference to FIG. 6. FIG. 6 is a sequence diagram showing an exemplary operation of the meeting assistance system 1 as a process flow S1. In the following, it is assumed that four users (user A, user B, user C, and user D) are participants of an online meeting. The meeting controller 11 of the server 10 and the meeting display units 21 of the user terminals 20 cooperate with one another to display the meeting screen 300 (see FIG. 4) on the user terminals 20 of the four users.

In step S11, the recording unit 12 of the server 10 records moving images including audio of the online meeting as meeting data in the meeting database 30. The recording unit 12 continuously records the meeting data as the online meeting progresses.

The meeting data may further include user identification information. The server 10 receives the moving images captured at the same time from the user terminals 20. Therefore, the recording unit 12 is able to specify a corresponding relationship between the audio and the user identification information at a certain time point. The recording unit 12 chronologically records this corresponding relationship and the meeting data in association with each other in the meeting database 30.

It is assumed that, in step S12 and thereafter, the user terminal 20 is a terminal of a user (user D in the examples of FIGS. 5A and 5B) who intends to use the chasing playback. In step S12, the meeting display unit 21 of the user terminal 20 receives an input by the user in relation to the content start time point. For example, the meeting display unit 21 receives an input by the user in relation to the content start time point via the time point input field 305 of the meeting screen 300. In one example, the meeting display unit 21 receives an input by a user, indicating that the content start time point is 5 minutes before.

In step S13, the request transmitter 22 of the user terminal 20 transmits a content generation request including the content start time point (a time point the online meeting is to be traced back) to the server 10. For example, the request transmitter 22 obtains the content start time point input to the time point input field 305, with pressing of the chasing play back button 306 as a trigger. The request transmitter 22 generates a content generation request including the content start time point, and transmits that content generation request to the server 10. The request receiver 13 of the server 10 receives the content generation request, thereby obtaining the content start time point.

In step S14, the content generator 14 of the server 10 retrieves from the meeting database 30 the meeting data for a time range starting from the content start time point, and generates content data corresponding to the meeting data. In one example, the content generator 14 generates content data corresponding to the meeting data of five minutes before and thereafter. The method of generating the content data and the data structure are not particularly limited. For example, the content generator 14 may generate the content data, associating a speaker of the audio with the user identification information. The content generator 14 continues to generate the content data until the reproduction of the content on the user terminal 20 catches up with the real time online meeting. Therefore, the end point of the time range varies depending on the reproduction speed of the content or the length of the reproduction period of the content.

In step S15, the output unit 15 of the server 10 transmits the content data to the user terminal 20. In the user terminal 20, the content reproduction unit 23 receives the content data.

In step S16, the content reproduction unit 23 reproduces the content at a reproduction speed faster than the original reproduction speed of the meeting data, while the online meeting is in progress. The content reproduction unit 23 processes the content data received from the server 10, and displays the content on the display device. If rendering of the content is not executed on the server 10 side, the content reproduction unit 23 executes the rendering based on the content data to display the content. When the content data represent the content itself, the content reproduction unit 23 displays the content as it is. The user terminal 20 outputs the audio according to the display of the content from an audio speaker. In this way, the content reproduction unit 23 displays the reproduction screen 400 (see the examples of FIGS. 5A and 5B) on the user terminal 20.

The reproduction speed of the content is not limited as long as it is faster than the original reproduction speed of the meeting data. In one example, the reproduction speed of the content is 2.0 times. The content reproduction unit 23 reproduces the content at high speed while the online meeting is in progress. The reproduction speed of the content may be determined by the content generator 14 or the content reproduction unit 23. When the reproduction of the content catches up with the real time online meeting, the content reproduction unit 23 ends the reproduction of the content. Then, the meeting display unit 21 displays the meeting screen 300 on the user terminal 20 again. In this way, the user terminal 20 switches its display from the reproduction screen 400 to the meeting screen 300.

Regarding step S14, the end point of the time range may be determined. For example, the end point of the time range may be a time at which the content start time point is obtained. Such time may be a time when the server 10 receives the content generation request, a time when the user operation related to pressing of the chasing playback button 306 is performed, or the like. In such a case, content data for the time range from the content start time point to the time indicating the end point is generated and transmitted to the user terminal 20. Then, in step S16, the content reproduction unit 23 may reproduce the content while the meeting display unit 21 displays the online meeting. In other words, the reproduction of the content and the displaying of the real time online meeting may be executed in parallel. When the reproduction of the content reaches the end point of the time range, the content reproduction unit 23 ends the reproduction of the content. The meeting display unit 21, on the other hand, continues to display the online meeting.

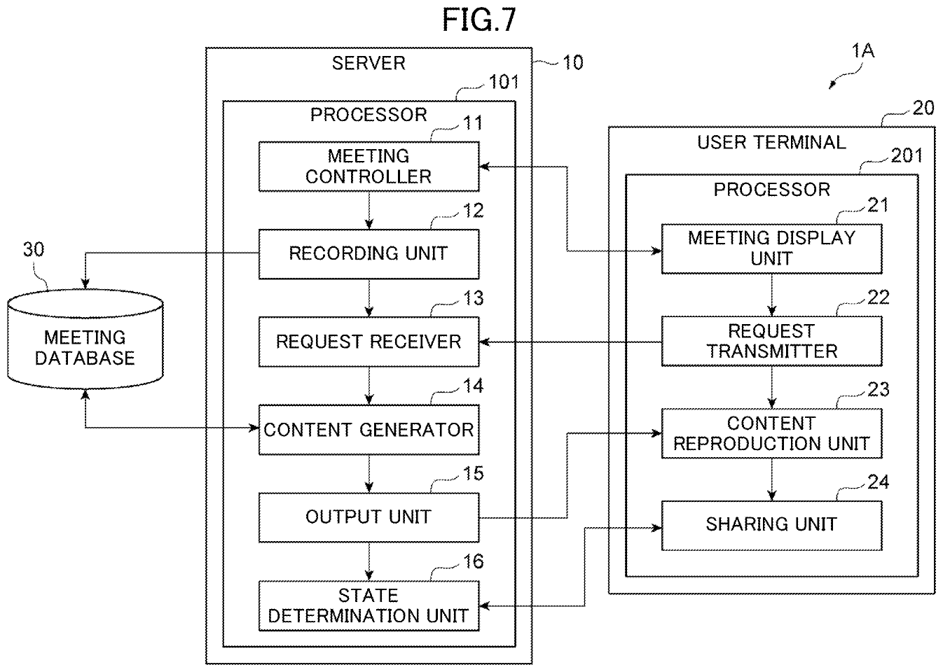

FIG. 7 is a diagram illustrating an exemplary functional configuration related to the meeting assistance system 1A. The meeting assistance system 1A is different from the meeting assistance system 1 in that, in the meeting assistance system 1A, the server 10 further includes a state determination unit 16 as its functional element and the user terminal 20 includes a sharing unit 24 as its functional element. The state determination unit 16 is a functional element that determines the user status and the progress state of the content reproduction. The status herein refers to a participation state of the user in the meeting. The progress state refers to the progress related to reproduction of the content. The sharing unit 24 is a functional element that cooperates with the state determination unit 16 of the server 10 to determine the user status and the progress state of the content reproduction.

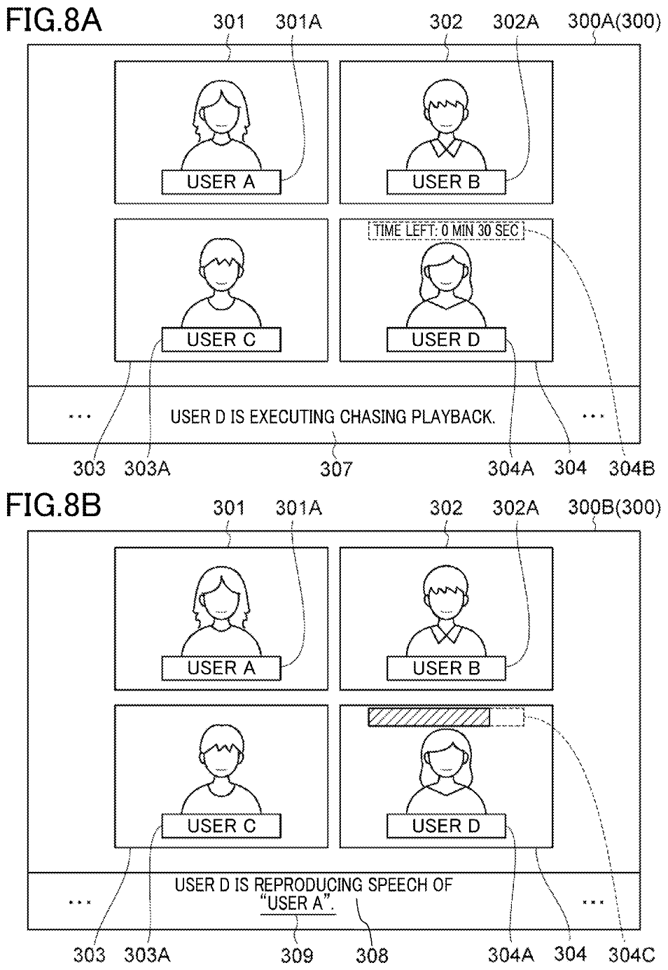

FIGS. 8A and 8B are diagrams showing another exemplary meeting screen 300. The example of FIG. 8A is an exemplary meeting screen 300A displaying a status and the progress state. The example of FIG. 8A assumes that the user D is reproducing the content. The meeting screen 300A includes a time indication field 304B and a status message 307. The time indication field 304B is a screen element that indicates a time left before the content reproduction ends. The time indication field 304B may be displayed within a display area where the moving image of the user reproducing the content is displayed. For example, the time indication field 304B may be displayed within the display area 304 where the moving image of the user D is displayed. The time indication field 304B indicates the time left in a form of, for example, “Time left: 0 min. 30 sec.” or the like. The status message 307 is a screen element that indicates that the user is reproducing the content as the status. The status message 307 displays information indicating which user is in the middle of the content reproduction in a form of, for example, “User D is executing chasing playback.” or the like. The forms of the time indication field 304B and the status message 307 are not limited to the above, and for example, the time indication field 304B and the status message 307 may be displayed in one location.

The example of FIG. 8B is an exemplary meeting screen 300B displaying a status and the progress state. The example of FIG. 8B assumes that the user D is reproducing the content. The meeting screen 300B includes an indicator 304C and a status message 308. The indicator 304C is a screen element that indicates the progress rate of the content reproduction. The indicator 304C may be displayed within a display area where the moving image of the user reproducing the content is displayed. For example, the indicator 304C may be displayed within the display area 304 where the moving image of the user D is displayed. The indicator 304C indicates the progress rate of the content in the time range. For example, the indicator 304C indicates the progress rate in the form of progress bar, in percentage, or the like. The status message 308 is a screen element that displays the speaker of the audio along with his/her status, according to the progress state of the content reproduction. The status message 308 has an embedded part 309 that displays user identification information. The status message 308 indicates information such as “User D is reproducing the speech of the ‘speaker’.” or the like. Here, the “speaker” corresponds to the embedded part 309. The embedded part 309 may display user identification information according to the progress state of the content reproduction. For example, the user identification information of user A is displayed in the embedded part 309 as in “User D is reproducing the speech of ‘user A’.” is displayed. The forms of the indicator 304C and the status message 308 are not limited to the above, and for example, the indicator 304C and the status message 308 may be displayed in one location.

The above-described time indication field 304B, the indicator 304C, and the status messages 307 and 308 may not be displayed, may be individually displayed, or may be displayed in any given combination.

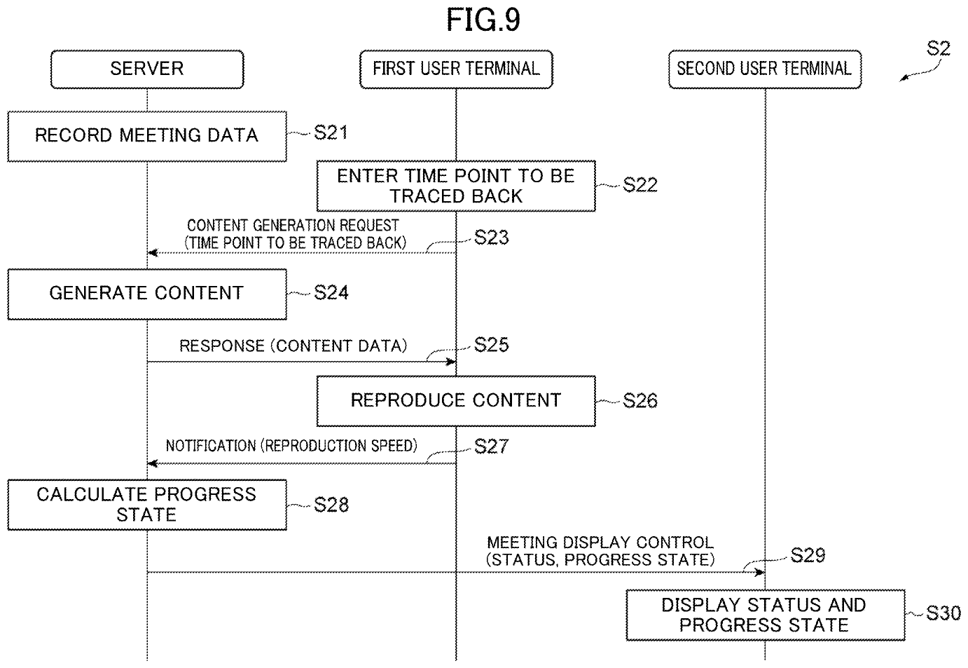

The following describes an operation of the meeting assistance system 1A with reference to FIG. 9. FIG. 9 is a sequence diagram showing an exemplary operation of the meeting assistance system 1A as a process flow S2. In the following, it is assumed that four users (user A, user B, user C, and user D) are in an online meeting. The meeting controller 11 of the server 10 and the meeting display units 21 of the user terminals 20 cooperate with one another to display the meeting screen 300 (see FIG. 4) on the user terminals 20 of the four users. Further, the user terminal 20 of the user who reproduces the content is referred to as a first user terminal, and the user terminal 20 of each of the other users is referred to as a second user terminal.

Since steps S21 to S26 are similar to steps S11 to S16 of the process flow S1, description for these steps are omitted.

In step S27, the sharing unit 24 of the first user terminal notifies the server 10 of the reproduction speed of the content. For example, with the reproduction of the content as a trigger, the sharing unit 24 obtains the reproduction speed of the content indicated by the reproduction speed field 405. The sharing unit 24 notifies the server 10 of the reproduction speed. The state determination unit 16 may determine that the user of the first user terminal is reproducing the content, when the notification of the reproduction speed is received from the first user terminal. For example, a change in the reproduction speed of the content, cueing the content, and the like may trigger further execution of step S27.

In step S28, the state determination unit 16 of the server 10 calculates the progress state based on the reproduction speed of the content and the elapsed time. In one example, the state determination unit 16 calculates the progress state by multiplying the reproduction speed of the content by the elapsed time, thereby calculating the reproduction position in the length of the reproduction period of the content. The elapsed time may be obtained, for example, from the first user terminal, or may be calculated using the time of receiving the notification of the reproduction speed in step S27 as the start time. The state determination unit 16 may calculate the time left before the reproduction of the content ends as the progress state. The state determination unit 16 may calculate the progress rate of the reproduction of the content as the progress state.

In step S29, the meeting controller 11 performs meeting display control for the second user terminal. For example, the meeting controller 11 transmits the status and the progress state to the second user terminal. In the second user terminal, the meeting display unit 21 obtains the progress state and the status.

In step S30, the meeting display unit 21 displays the progress state and the status. For example, the meeting display unit 21 of the user terminal 20 of each of the users A, B, and C displays the meeting screen 300A (see example (a) of FIG. 8) on the display device. With the display of the time indication field 304B and the status message 307 in the meeting screen 300A, the status of the user D and the progress state of the content reproduction are shared with the users A, B, and C.

Regarding step S27, if the reproduction speed of the content is decided on the server 10 side, the sharing unit 24 does not have to notify the reproduction speed.

### Advantages

As described above, a meeting assistance system according to an aspect of the present disclosure includes at least one processor. The at least one processor may: record meeting data including audio of an online meeting; obtain a time point the online meeting is to be traced back from a terminal of a user; generate content corresponding to the meeting data for a time range from the time point and thereafter; and cause the terminal of the user to reproduce the content at a reproduction speed faster than an original reproduction speed of the meeting data while the online meeting is in progress.

A meeting assistance method according to an aspect of the present disclosure is executable by a meeting assistance system including at least one processor. The meeting assistance method includes: recording meeting data including audio of an online meeting; obtaining a time point the online meeting is to be traced back from a terminal of one user; generating content corresponding to the meeting data for a time range from the time point and thereafter; and causing the terminal of the user to reproduce the content at a reproduction speed faster than an original reproduction speed of the meeting data while the online meeting is in progress.

A meeting assistance program according to an aspect of the present disclosure causes a computer to: record meeting data including audio of an online meeting; obtain a time point the online meeting is to be traced back from a terminal of a user; generate content corresponding to the meeting data for a time range from the time point and thereafter; and cause the terminal of the user to reproduce the content at a reproduction speed faster than an original reproduction speed of the meeting data while the online meeting is in progress.

In the above-described aspects, content corresponding to the meeting data at or later than the time point to which the online meeting is traced back is generated. Then, the content is reproduced at high speed on the terminal of the user so as to let the user catch up with the online meeting in progress. This provides an environment that allows grasping of the content of the meeting before the current time point.

The above-mentioned Patent Document 1 describes a network meeting system that records meeting information while the meeting is in progress, and when an attendee who has joined the meeting in the middle thereof is recognized, creates a summary of the meeting information up to that point and separately provides the created summary to the half-way attendee. The technology of Patent Document 1, however, is not a technology to perform chasing playback of the meeting content the attendee has missed while attending the meeting. Further, since the technology of Patent Document I creates a summary, there may be a missing part of the meeting content.

The above-mentioned Patent Document 2 describes a video conference system that rewinds and reproduces a video image or an audio of speech if an electronic conference participant misses that speech. The technology of Patent Document 2, however, is not a technology to reproduce the audio and the video at high speed upon rewinding. Therefore, an attendee is not able to quickly follow the meeting content.

With the above-described aspects of the present disclosure, to the contrary, content corresponding to meeting data for a time range starting from a time point to which the online meeting is traced back is reproduced at high speed. This allows chasing playback, without missing a part of the meeting content the attendee has missed while attending the meeting. Further, the reproduction of the content at high speed allows the user to quickly follow the meeting content.

The meeting assistance system according to another aspect may be such that the at least one processor may cause a terminal of another user different from the user to display a status indicating that the user is reproducing the content. In this case, the status of the user reproducing the content is shared among the users attending the online meeting. Since the other user can grasp the status, a smooth progress of the online meeting is possible.

The meeting assistance system according to another aspect may be such that the at least one processor may: calculate a progress state based on a reproduction speed of the content and an elapsed time; and cause the terminal of the other user to display the progress state. In this case, the progress state of the user reproducing the content is shared among the users attending the online meeting. Since the other user can grasp the progress state, a smooth progress of the online meeting is possible.

The meeting assistance system according to another aspect may be such that the at least one processor may: obtain user identification information that specifies a user who is a speaker of audio; generate the content, associating the audio and the user identification information; and cause the terminal of the other user to display, along with the status, the user identification information according to the progress state. In this case, information about whose speech the user, reproducing the content, is listening to is shared among the users attending the online meeting. Therefore, the other user is able to grasp the progress state in detail.

The meeting assistance system according to another aspect may be such that the at least one processor may calculate a time left before reproduction of the content ends as the progress state. In this case, the time left before the reproduction of the content ends is shared with the other user. Therefore, the other user is able to accurately grasp the progress state.

The meeting assistance system according to another aspect may be such that the at least one processor may calculate a progress rate of reproduction of the content as the progress state. In this case, the progress rate of the reproduction of the content is shared with the other user. Therefore, the other user is able to intuitively grasp the progress state.

The meeting assistance system according to another aspect may be such that: an end point of the time range is a time at which the time point is obtained; and the at least one processor may cause the terminal of the one user to display the online meeting during the reproduction of the content. In this case, content from the time point to be traced back to the time at which the time point is obtained is reproduced at high speed, and the online meeting after the time at which the time point is obtained is displayed in real time. In this way, the time required for reproduction of content can be suppressed.

### Modifications

The present disclosure has been described above in detail based on the embodiments. However, the present disclosure is not limited to the embodiments described above. The present disclosure may be changed in various ways without departing from the spirit and scope thereof.

The content generator 14 may generate content data of text format, by executing audio recognition to the meeting data. For example, the content generator 14 may generate content data by converting at least speech of a user into text. The content generator 14 may generate content data constituted only by text data, or content data containing a combination of text data and audio or a moving image. The content generator 14 may generate content data specifying the speaker of each audio by associating the user identification information with the text data. The content reproduction unit 23 may display the content data in a text data format on the display device. In this way, an environment that allows quick grasping of the meeting content can be provided.

The content reproduction unit 23 may execute skip-reproduction that skips a part of content. The skip-reproduction may be triggered by, for example, a change in the reproduction position of the progress bar 408, a cuing operation with the operation interface 406, and the like. With the skip-reproduction, the time required for reproduction of content can be suppressed.

Content may be labeled with one or more labels. For example, the content generator 14 may chronologically detect a sound volume of the meeting data or the number of speakers, and determine whether a value detected is greater than or equal to a predetermined threshold. The content generator 14 may generate content data with a label “Meeting is Active” or the like, at a time when the detected value is greater than or equal to the threshold. Other examples of labels include “Meeting is Quiet”, “Specific User is Speaking”, “Speaker is Switched”, and the like. The content reproduction unit 23 may execute the skip-reproduction, using the label as a cueing position. The cueing may be triggered by a user operation, or may be automatically performed without receiving a user operation. In one example, the content reproduction unit 23 may perform the skip-reproduction by automatic cueing so as to reproduce only the content in the time range indicated by the label. By enabling reproduction of a part of the content where the meeting was active, the convenience of the user is improved.

The above-described embodiments deal with a case where the online meeting is a form of meeting that shares moving images. However, the online meeting may be a form of meeting sharing only audio. Further, while the above-described embodiments deal with a case where the state determination unit 16 calculates the progress state, the progress state may be shared by the first user terminal with the second user terminal. In another example, a pause request of the content may be transmitted from the second user terminal to the first user terminal. The meeting display unit 21 of the first user terminal having received the pause request may display the meeting screen 300.

In the embodiments described above, the meeting assistance systems 1 and 1A are each constituted by the server 10. However, the meeting assistance system may be applied to an online meeting between user terminals 20 without intervening the server 10. In this case, each functional element of the server 10 may be implemented on any of the user terminals, or may be separately implemented on a plurality of user terminals. In this regard, the meeting assistance program may be implemented as a client program. The meeting assistance system may be configured using a server or may be configured without using a server. That is, the meeting assistance system may be a form of client-to-server system, a P2P (Peer-to-Peer) that is a client-to-client system, or an E2E (End-to-End) encryption mode. The client-to-client system improves the confidentiality of the online meeting. In one example, leakage of audio and the like of an online meeting to a third party can be avoided with a meeting assistance system that performs E2E encryption of an online meeting between user terminals 20.

In the present disclosure, the expression “at least one processor executes a first process, a second process, and . . . executes an n-th process.” or the expression corresponding thereto is a concept including the case where the execution bodies (i.e., processors) of the n processes from the first process to the n-th process change in the middle. In other words, this expression is a concept including both a case where all of the n processes are executed by the same processor and a case where the processor changes during the n processes, according to any given policy.

The processing procedure of the method executed by the at least one processor is not limited to the example of the above embodiments. For example, a part of the above-described steps (processing) may be omitted, or each step may be executed in another order. Any two or more of the above-described steps may be combined, or some of the steps may be modified or deleted. As an alternative, the method may include a step other than the steps, in addition to the steps described above.

Any part or all of each functional part described herein may be achieved by a program. The program mentioned in the present specification may be distributed by being non-temporarily recorded in a computer-readable recording medium, may be distributed via a communication line (including wireless communication) such as the Internet, or may be distributed in the state of being installed in an any given terminal.

One skilled in the art may conceive of additional effects or various modifications of the present disclosure based on the above description, but the aspect of the present disclosure is not limited to the individual embodiments described above. Various additions, modifications, and partial deletions can be made without departing from the conceptual idea and the gist of the present disclosure derived from the contents defined in the claims and equivalents thereof.

For example, a configuration described herein as a single device (or component, the same applies hereinbelow) (including configurations illustrated as a single device in the drawings) may be achieved by multiple devices. Alternatively, a configuration described herein as a plurality of devices (including configurations illustrated as a plurality of devices in the drawings) may be achieved by a single device. Alternatively, some or all of the means or functions included in a certain device (e.g., a server) may be included in another device (e.g., a user terminal).

Not all of the items described herein are essential requirements. For example, matters described herein but not recited in the claims can be referred to as optional additional matters.

The applicant is only aware of the known technology described in the “CITATION LIST” section of this document. It should also be noted that this disclosure is not necessarily intended to solve problems in that known technology. The problem to be solved by the present disclosure should be recognized in consideration of the entire specification. For example, when there is a statement herein that a particular configuration produces a certain effect, it can be said that the problem corresponding to that certain effect is solved. However, the description of the effect is not necessarily intended to make such a specific configuration an essential requirement.

### DESCRIPTION OF REFERENCE CHARACTERS

1, 1A Meeting Assistance System
10 Server
11 Meeting Controller
12 Recording Unit
13 Request Receiver
14 Content Generator
15 Output Unit
16 State Determination Unit
20 User Terminal
21 Meeting Display Unit
22 Request Transmitter
23 Content Reproduction Unit
24 Sharing Unit
30 Meeting Database
300, 300A, 300B Meeting Screen
304B Time Indication Field
304C Indicator
307, 308 Status Message
309 Embedded Part
400, 400A, 400B Reproduction Screen
P1 Server Program
P2 Client Program

1-9. (canceled)

10. A meeting assistance system, comprising at least one processor configured to:
record meeting data including audio of an online meeting;
obtain a time point the online meeting is to be traced back from a terminal of a user;
generate content corresponding to the meeting data for a time range from the time point and thereafter; and
cause the terminal of the user to reproduce the content at a reproduction speed faster than an original reproduction speed of the meeting data while the online meeting is in progress.

11. The meeting assistance system according to claim 10, wherein the at least one processor is configured to cause a terminal of another user different from the user to display a status indicating that the user is reproducing the content.

12. The meeting assistance system according to claim 11, wherein the at least one processor is configured to:
calculate a progress state based on the reproduction speed of the content and an elapsed time; and
cause the terminal of the other user to display the progress state.

13. The meeting assistance system according to claim 12, wherein the at least one processor is configured to calculate a time left before reproduction of the content ends as the progress state.

14. The meeting assistance system according to claim 12, wherein the at least one processor is configured to calculate a progress rate of reproduction of the content as the progress state.

15. The meeting assistance system according to claim 12, wherein
the audio includes a speech, and
the at least one processor is configured to:
obtain user identification information that specifies a user who is a speaker of the speech;
generate the content, associating the speech and the user identification information; and
cause the terminal of the other user to display, along with the status, the user identification information according to the progress state.

16. The meeting assistance system according to claim 15, wherein the at least one processor is configured to calculate a time left before reproduction of the content ends as the progress state.

17. The meeting assistance system according to claim 15, wherein the at least one processor is configured to calculate a progress rate of reproduction of the content as the progress state.

18. The meeting assistance system according to claim 10, wherein
an end point of the time range is a time at which the time point is obtained, and
the at least one processor is configured to cause the terminal of the user to display the online meeting during reproduction of the content.

19. A meeting assistance method executable by a meeting assistance system including at least one processor, the method comprising:
recording meeting data including audio of an online meeting;
obtaining a time point the online meeting is to be traced back from a terminal of a user;
generating content corresponding to the meeting data for a time range from the time point and thereafter; and
causing the terminal of the user to reproduce the content at a reproduction speed faster than an original reproduction speed of the meeting data while the online meeting is in progress.

20. The meeting assistance method according to claim 19, further comprising causing a terminal of another user different from the user to display a status indicating that the user is reproducing the content.

21. The meeting assistance method according to claim 20, further comprising:
calculating a progress state based on the reproduction speed of the content and an elapsed time; and
causing the terminal of the other user to display the progress state.

22. The meeting assistance method according to claim 21, further comprising calculating a time left before reproduction of the content ends as the progress state.

23. The meeting assistance method according to claim 21, further comprising calculating a progress rate of reproduction of the content as the progress state.

24. The meeting assistance method according to claim 21, wherein
the audio includes a speech, and
the method further comprises:
obtaining user identification information that specifies a user who is a speaker of the speech;
generating the content, associating the speech and the user identification information; and
causing the terminal of the other user to display, along with the status, the user identification information according to the progress state.

25. The meeting assistance method according to claim 24, further comprising calculating a time left before reproduction of the content ends as the progress state.

26. The meeting assistance method according to claim 24, further comprising calculating a progress rate of reproduction of the content as the progress state.

27. The meeting assistance method according to claim 19, wherein
an end point of the time range is a time at which the time point is obtained, and
the method further comprises causing the terminal of the user to display the online meeting during reproduction of the content.

28. A non-transitory computer-readable medium storing thereon a meeting assistance program that, when executed, causes a computer to:
record meeting data including audio of an online meeting;
obtain a time point the online meeting is to be traced back from a terminal of one user;
generate content corresponding to the meeting data for a time range from the time point and thereafter; and
cause the terminal of the user to reproduce the content at a reproduction speed faster than an original reproduction speed of the meeting data while the online meeting is in progress.

29. The non-transitory computer-readable according to claim 28, wherein the program, when executed, further causes a computer to:
calculate a progress state based on the reproduction speed of the content and an elapsed time; and
cause the terminal of the other user to display the progress state.
